(19) United States
(12) Patent Application Publication
(10) Pub. No.: US 2006/0040037 A1
(43) Pub. Date: Feb. 23, 2006

(54) Prodigy pizza-John Endicott's original low-carb pizza

(76) Inventor: Johnny Keith Endicott, Endicott, KY (US)

Correspondence Address: Johnny Keith Endicott, P.O. Box 214, Allen, KY, 41601, US

(21) Appl. No.: 10/777,671

(22) Filed: Aug. 18, 2004

(51) Int. Cl. A23C 19/00

(52) U.S. Cl. 426/582

(57) ABSTRACT

The process of composition applies the use of cheese in place of traditional flour based crust. Upon the baking process of heating the pie to approximately 350 degrees for about fifteen minutes the cheese forms a bond with the cheese on top of the pizza sealing in the contents. The process allows the body required to hold while eating without the including the additional carbohydrates.

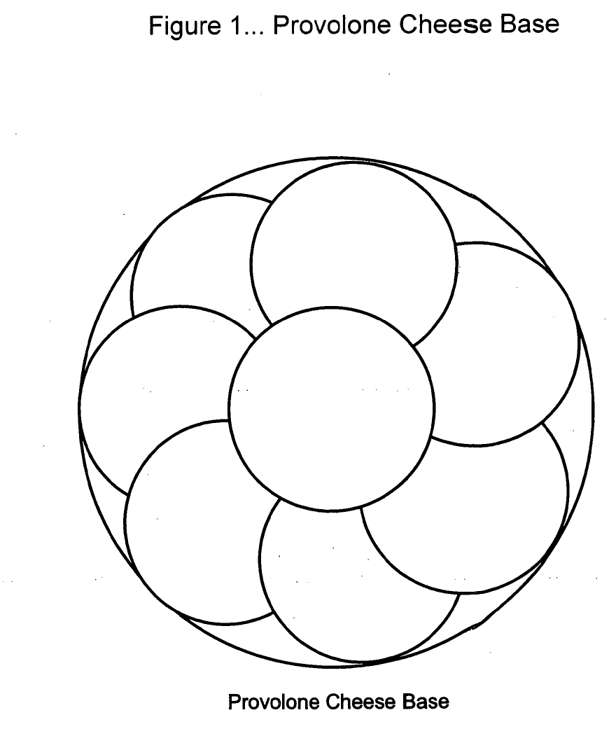

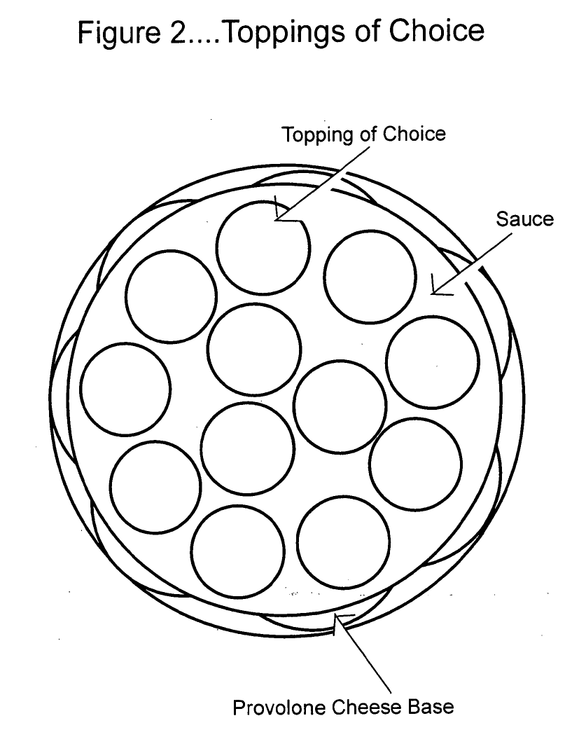

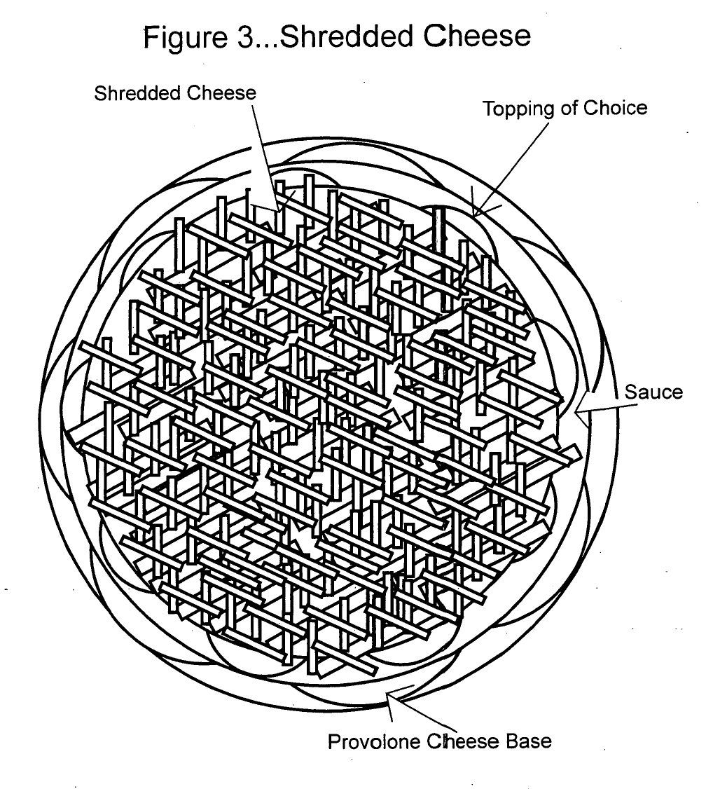

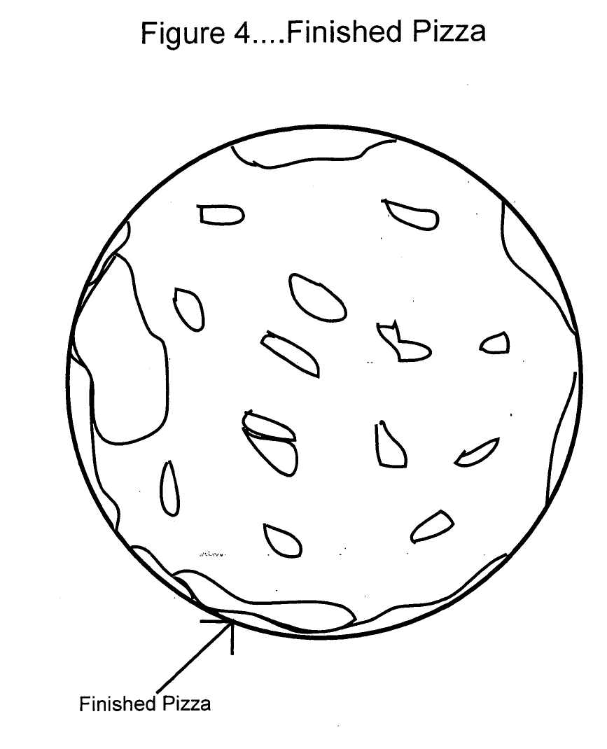

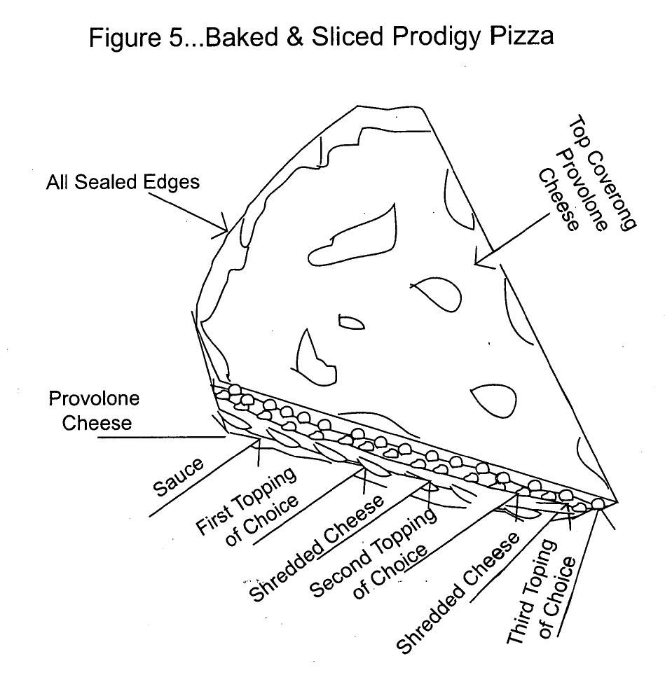

### DETAILED DESCRIPTION

Although Prodigy is similar in taste and composition to traditional pizza, many elements are very different and unique. The taste of Prodigy is much more rich and satisfying than traditional pizzas utilizing a flour crust. Each serving of Prodigy pizza contains only about 4 grams of carbohydrates as compared to 25 to 50 in traditional pizzas (based on a 12 inch pizza pie).

In traditional pizzas, the base or crust of the pizza is made of wheat flour (which is high in carbohydrates), and then the traditional toppings of choice are added.

In contrast to traditional pizza composition, Prodigy uses a base and sides made of sliced provolone (or mozzarella) in either a pan or deep-dish, and can be multi-layered.

After the first or base layer of provolone (or mozzarella) is applied to the greased pizza pan, the pizza sauce is added, followed by the toppings of choice, then a small amount of shredded cheese (to help bind the toppings). After all toppings are in place the entire pie will be covered by yet another layer of sliced cheese, such as provolone (or mozzarella) as a top covering. In the baking process the top, side layer & bottom layers bond together and the toppings and their flavors are sealed inside.

Note: In assembling the Prodigy, as many topping of choice as desire can be added (followed by a small amount of shredded cheese after each topping).

Baking Instructions:

The pizza can then be either micro waved on medium-high for about 4 minutes or baked in a traditional oven on 300 degrees for about 15 minutes. After micro waving or baking, a resting period of about 15 minutes is recommended, thus allowing the pizza to cool and solidify before slicing.

### BACKGROUND OF INVENTION

Although I had been a long time traditional crust pizza eater, age and lack of exercise determined I would have to slow down on my carbohydrate consumption or increase my exercise level. Since I had a severe handicap from birth, effectively increasing my exercise level wasn't a viable option.

I love pizza though and I didn't want to give it up. I had been on a low carbohydrate diet for several months and had lost a lot of weight, but had to give up on one of my most favorite foods—Pizza.

In February of 2003, I started tossing some ideas around wondering how could I reduce the carbohydrates per serving traditional crust pizza. Then it dawned on me, get rid of the crust altogether. To me, traditional pizza crust adds texture and a base to hold the toppings on and a whole lot of carbohydrates, but not a lot of taste. Dropping the crust open up a whole new world of culinary creation. I would create an ultra low-carb pizza that I and other low-carb dieters (including diabetics) could enjoy on a regular basis without incurring guilt or health problems associated with consuming high carb foods (like traditional crust pizza).

I have research the market before applying for a patent, I discovered through my available resources that this type of pizza, by its ingredients, composition, and general nature had not been patented or marketed. Thus, the Prodigy Pizza was born.

### DESCRIPTIVE TITLE OF THE INVENTION

Prodigy Pizza is an Ultra Low-Carb Pizza that utilizes cheese in place of traditional crust and completely seals the toppings inside by a top covering of cheese while retaining a reasonable overall texture and exceptional pizza flavor.

The name itself “Prodigy” in itself is descriptive by nature, projecting a newness and something that stands out from the rest or the existing.

### BRIEF DESCRIPTION OF THE DRAWINGS

Below in Illustration A is a drawing of a Prodigy Pizza in whole form (including how it differs from traditional crust pizza), and a cross section drawing in Illustration B.

The drawing in Illustration A shows how the crust has been completely removed and replace with cheese on both the sides, and bottom.

[image]

Below in Illustration B is a drawing of a Prodigy Pizza in cross-sectional form (including how it differs from traditional crust pizza).

This illustration shows the different internal layering that take place to actually assemble The Prodigy Pizza.

[image]

1. I, Johnny Keith Endicott, of Endicott, Ky., mailing address, P.O. Box 214, Allen, Ky. 41601, claim that the John Endicott's Original Low-Carb Pizza, know as Prodigy Pizza, allows the consumer to enjoy the taste & texture of pizza without the intake of excessive carbohydrates that traditional flour base or crust pizza's offer. This is especially important for those on a low carbohydrate Lifestyle. Furthermore, since my pizza design does not use a flour base or crust, it is more enjoyable than traditional designs because it is totally sealed in cheese, which allows it to be less messy and retain all of its flavor and moisture inside. It is a unique design, unlike any other pizza on the market today.
